(19) United States
(12) Patent Application Publication
(10) Pub. No.: US 2025/0053243 A1
(43) Pub. Date: Feb. 13, 2025

(54) LAPTOP COMPUTER

(71) Applicant: Acer Incorporated, New Taipei City (TW)

(72) Inventors: Hung-Chi Chen, New Taipei City (TW); Cheng-Han Lin, New Taipei City (TW)

(73) Assignee: Acer Incorporated, New Taipei City (TW)

(21) Appl. No.: 18/404,888

(22) Filed: Jan. 5, 2024

(30) Foreign Application Priority Data
Aug. 11, 2023 (TW) 112130380

(51) Int. Cl. G06F 3/02; G06F 1/16; H01H 13/14; H01H 13/70

(52) U.S. Cl. CPC G06F 3/0202; G06F 1/1662; H01H 13/14; H01H 13/70

(57) ABSTRACT

A laptop computer includes a body, a bracket disposed in the body, a latching member movably disposed on the bracket, a first key module detachably assembled onto the bracket, and a second key module disposed on the bracket. A part of the first key module is located on a moving path of the latching member. The latching member is adapted to be driven by an external force to push the part of the first key module away from the bracket.

### CROSS-REFERENCE TO RELATED APPLICATION

This application claims the priority benefit of Taiwan application serial no. 112130380, filed on Aug. 11, 2023. The entirety of the above-mentioned patent application is hereby incorporated by reference herein and made a part of this specification.

### BACKGROUND

### Technical Field

The disclosure relates to a laptop computer.

### Description of Related Art

With the development of e-sports industry, there are various input modules specially designed for e-sports on the market, such as keyboards and mice. Taking gaming keyboards as an example, compared with general keyboards used for document processing or other business affairs, gaming keyboards mainly require that the pressing feel of the keys should have favorable tapping and fast signal transmission effects, and that the addition of new keys are used as special function keys to execute corresponding commands or macros, so that it may allow players to operate more quickly and conveniently.

However, the above-mentioned requirements apparently pose difficulties for laptop computers and may not be easily achieved. The reason is that, unlike like desktop computers, existing laptop computers may be unable to replace relevant parts (such as the above-mentioned keyboard or keys of the keyboard) at any time according to the requirements. In this way, the only way for users of the laptop computers is to update.

In order to overcome the above-mentioned problems, there are related technologies on the market that may replace the keyboards of the laptop computers, so that the users of laptop computers may slightly meet the above-mentioned usage requirements. However, what the above-mentioned technology may replace is only the keycap of the key, and the function it achieves is only a recognition effect serving as a maintenance update or change of keys. Requirements such as the pressing stroke, pressing feel, or further appearance effects of the keys are still unable to be met.

### SUMMARY

The disclosure provides a laptop computer, and the keyboard thereof is modularized and replaceable.

A laptop computer of the disclosure includes a body, a bracket disposed in the body, a latching member movably disposed on the bracket, a first key module detachably assembled onto the bracket, and a second key module disposed on the bracket. A part of the first key module is located on a moving path of the latching member. The latching member is adapted to be driven by an external force to push the part of the first key module away from the bracket.

Based on the above, the keyboard of the laptop computer has the first key module and the second key module that are different from each other. The first key module is detachably assembled onto the bracket, and the driving thereof with the use of the latching member allows the first key module to be dismounted from the bracket. In this way, through the modularization of the keys and the simple latching mechanism, the user may replace different types of key modules according to the usage requirements, such as the pressing stroke, pressing feel, further appearance effects, etc., thereby improving the scope of use of the laptop computers.

### BRIEF DESCRIPTION OF THE DRAWINGS

FIG. 1 is a schematic view of a laptop computer according to an embodiment of the disclosure.

FIG. 2A is a schematic exploded view of the keyboard of the laptop computer of FIG. 1.

FIG. 2B shows the keyboard of FIG. 2A from another perspective.

FIG. 2C shows corresponding relationships of components of different key modules of a keyboard.

FIG. 3 is an exploded view of the first key module of FIG. 2A and FIG. 2B.

FIG. 4A and FIG. 4B are partial cross-sectional views of a first key module before and after driving.

FIG. 5 is a simple schematic view of a key module being driven according to another embodiment of the disclosure.

### DESCRIPTION OF THE EMBODIMENTS

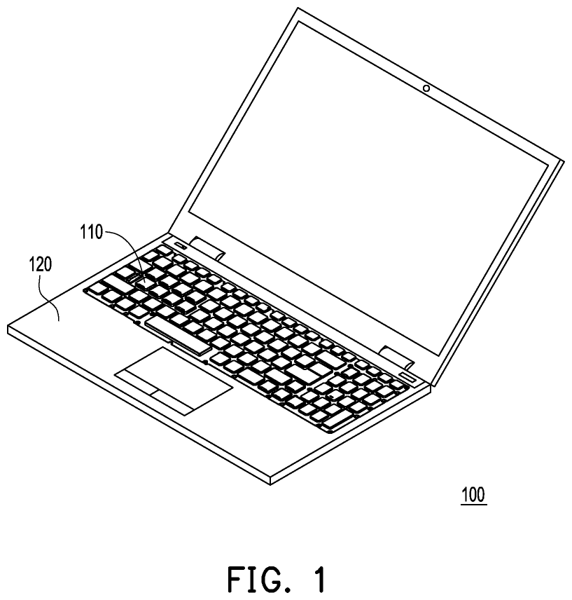

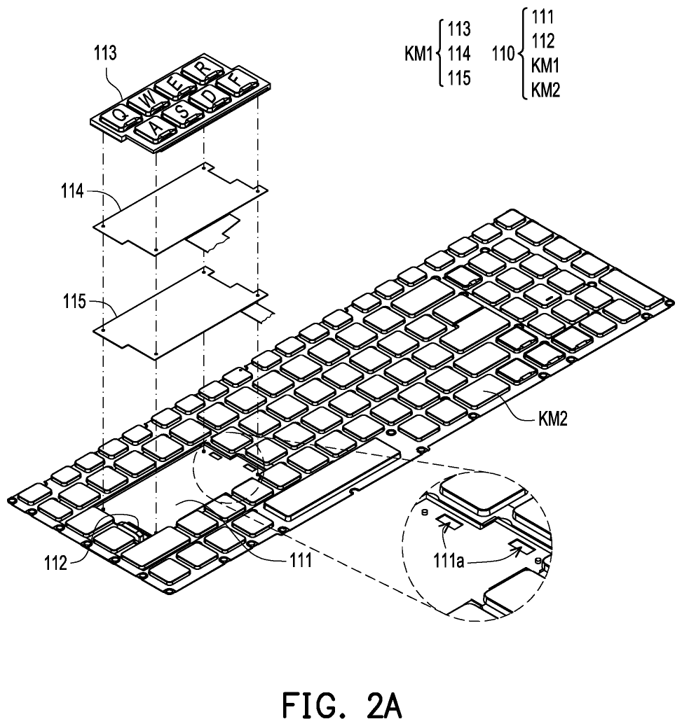

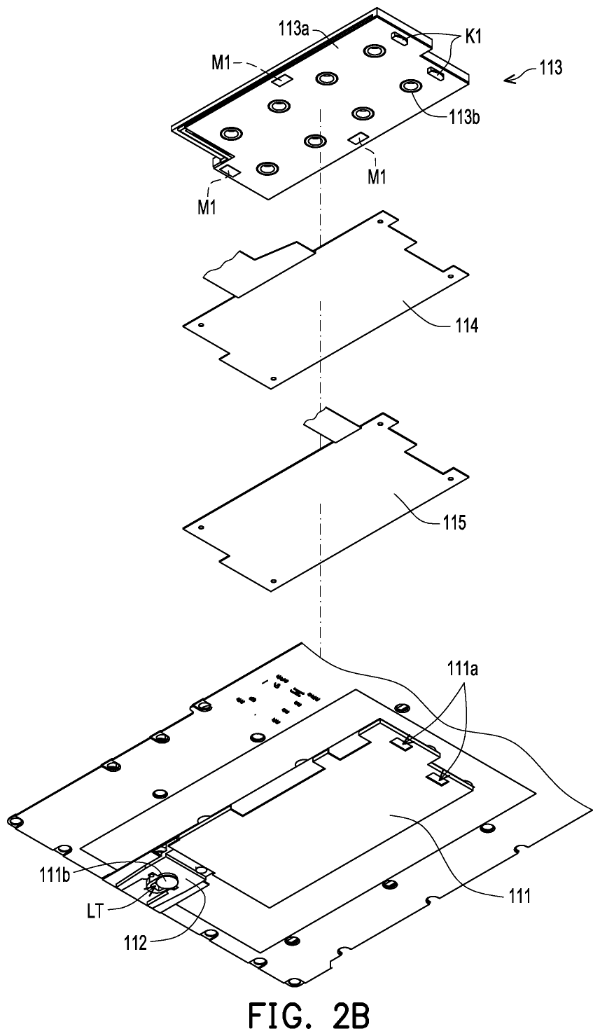

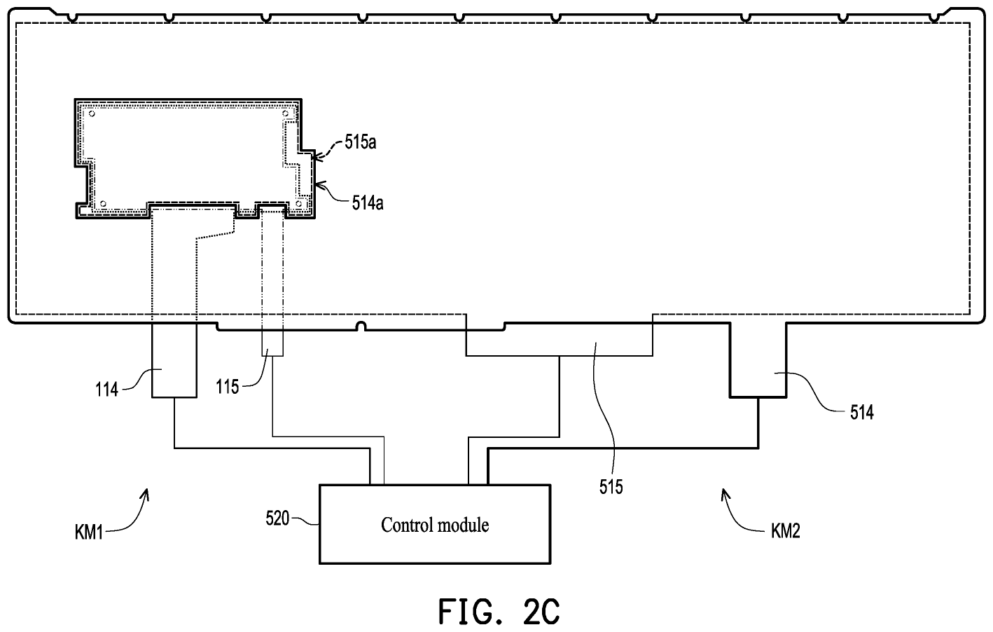

FIG. 1 is a schematic view of a laptop computer according to an embodiment of the disclosure. FIG. 2A is a schematic exploded view of the keyboard of the laptop computer of FIG. 1. FIG. 2B shows the keyboard of FIG. 2A from another perspective. Please refer to FIG. 1, FIG. 2A, and FIG. 2B at the same time. In the embodiment, a laptop computer 100 includes a keyboard 110 and a body 120. As shown in the prior art, the keyboard 110 is disposed and exposed on the surface of the body 120 for easy operation. The difference is that the keyboard 110 of the embodiment includes a bracket 111 and a first key module KM1 and a second key module KM2 disposed thereon. The bracket 111 is disposed in the body 120. The second key module KM2 is fixed on the bracket 111 by adopting a fixed structure, but the first key module KM1 is assembled onto the bracket 111 by adopting a detachable mechanism.

As shown in FIG. 2A and FIG. 2B, the bracket 111 has an engaging hole 111a, the bottom of the first key module KM1 has a hook K1, and the keyboard 110 also includes a latching member 112 movably disposed on the bracket 111. The latching member 112 and the hook K1 are substantially located on opposite sides of the first key module KM1, and a part of the first key module KM1 is located on a moving path of the latching member 112. Accordingly, the first key module KM1 may be engaged into the engaging hole 111a with the hook K1 in a tilted state. Then, the first key module KM1 is placed flat on the bracket 111, and then the latching member 112 is used to latch the first key module KM1 to complete the purpose of assembling the first key module KM1 onto the bracket 111. Conversely, a user applies a force on the latching member 112 to move the latching member 112, so that after the part of the first key module KM1 is pushed away from the bracket 111, the hook K1 may be withdrawn from the engaging hole 111a, and the first key module KM1 may be successfully dismounted from the bracket 111 so as to achieve the effect of replacement.

The first key module KM1 of the embodiment includes a key group 113, a first tactile film 114, and a first backlight module 115. The key group 113 has a bottom plate 113a. The first tactile film 114 is disposed between the bracket 111 and the bottom plate 113a. The first backlight module 115 includes a flexible circuit board and a plurality of light-emitting elements (such as LEDs, not shown here) disposed thereon, which are disposed between the bracket 111 and the bottom plate 113a (substantially located between the bracket 111 and the first tactile film 114) and used to provide light. The light is projected upwards to project the first key module KM1 from a top surface of the key group 113 (an upper surface of the key group 113 shown in FIG. 2A).

From FIG. 2A and FIG. 2B, it is obvious that the key group 113, the first tactile film 114, and the first backlight module 115 may be disassembled correspondingly with respect to the bracket 111, which may therefore provide the effect of simple replacement. FIG. 2C shows corresponding relationships of components of different key modules of a keyboard. Here, the second key module KM2 presents different components in FIG. 2A and FIG. 2C. Please refer to FIG. 2A to FIG. 2C at the same time. In the embodiment, like the corresponding relationship of the key structure shown in FIG. 2A, the second key module KM2 of the embodiment also includes the second tactile film 514 and the second backlight module 515 similar to the above (first tactile film 114 and first backlight module 115). The functions provided by the second tactile film 514 and the second backlight module 515 are the same as the functions provided by the above-mentioned first tactile film 114 and first backlight module 115, and therefore the details will not be repeated here. In other words, viewing the first key module KM1 and the second key module KM2 at the same time is equivalent to dividing a standard QWERTY keyboard into two different modules on the premise that the keyboard 110 of the embodiment is a standard QWERTY keyboard. The first key module KM1 is the first four keys (Q, W, E, R) of the first row and the first four keys (A, S, D, F) of the second row in the letter area of the QWERTY keyboard, and the second key module KM2 is the rest of the keys. Such is the case since the keys included in the first key module KM1 are frequently used in the field of e-sports. Therefore, in addition to being susceptible to wear and tear, it is also necessary to respond to different pressing requirements and various different key groups that may meet the requirements. As a result, through the detachable feature of the first key module KM1, the laptop computer 100 may overcome the current situation and meet the above-mentioned requirements.

Under such a premise, the key group, the tactile film, and the backlight module of the different key modules are all disposed separately. That is, the first tactile film 114 and the second tactile film 514 are independent of each other and do not belong to each other. The first tactile film 114 and the second tactile film 514 are electrically connected to a control module 520, respectively. Here, the control module 520 is, for example, an integration of the main board of the laptop computer 100 and the related signal processing components thereon. Similarly, the first backlight module 115 and the second backlight module 515 are also independent of each other and do not belong to each other. The first backlight module 115 and the second backlight module 515 are also electrically connected to the control module 520, respectively.

Furthermore, in order to make the above-mentioned components adapt to each other structurally, an effective tactile area of the second tactile film 514 of the embodiment has a first notch 514a, and an effective tactile area of the first tactile film 114 is located inside the first notch 514a. An effective light source area of the second backlight module 515 has a second notch 515a, and an effective light source area of the first backlight module 115 is located inside the second notch 515a. In other words, the relationship between the first tactile film 114 and the second tactile film 514, and the relationship between the first backlight module 115 and the second backlight module 515 of the embodiment all conform to the filling (or puzzle) mode of the first key module KM1 with respect to the second key module KM1 shown in FIG. 2A. It is not limited here as to what the key markings of the first key module KM1 are. In other embodiments not shown, at least one of the key markings of the keyboard 110 may be disposed as a detachable state like the above-mentioned first key module KM1 according to requirements.

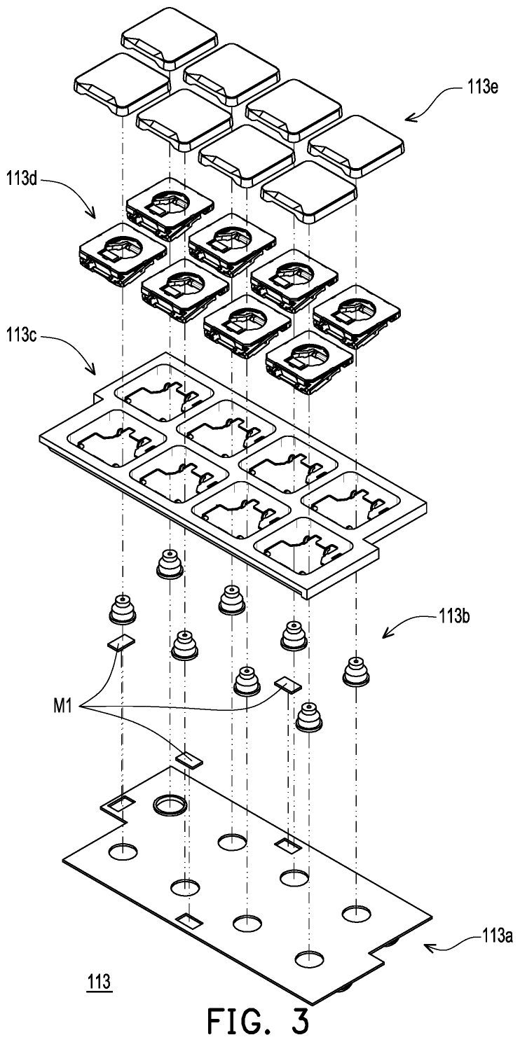

FIG. 3 is an exploded view of the first key module of FIG. 2A and FIG. 2B. Please refer to FIG. 3. In addition to the above-mentioned bottom plate 113a, the key group 113 of the embodiment further includes elastic domes 113b, a frame 113c, scissor structures 113d, and key caps 113e. The bottom plate 113a is carried on the bracket 111. The frame 113c is disposed on the bottom plate 113a, and a part of the frame 113c is located on the moving path of the latching member 112. The scissor structures 113d are movably disposed on the bottom plate 113a and surround the elastic domes 113b. The key caps 113e are respectively disposed on the scissor structures 113d. The top parts of the elastic domes 113b are respectively connected to the key caps 113e. Here, in the assembled key group 113, the elastic domes 113b pass through the bottom plate 113a and stand on the first tactile film 114.

Please refer to FIG. 2A and FIG. 2B again. It should also be mentioned that the first key module KM1 of the embodiment also includes at least one magnetic attraction member (for example, a magnet, and three magnetic attraction members Ml are used as an example here) disposed on the bottom plate 113a, and the bracket 111 has magnetic attraction such that the first key module KM1 is fixed on the bracket 111 through magnetic attraction, so that the convenience for users to disassemble the first key module KM1 may be improved.

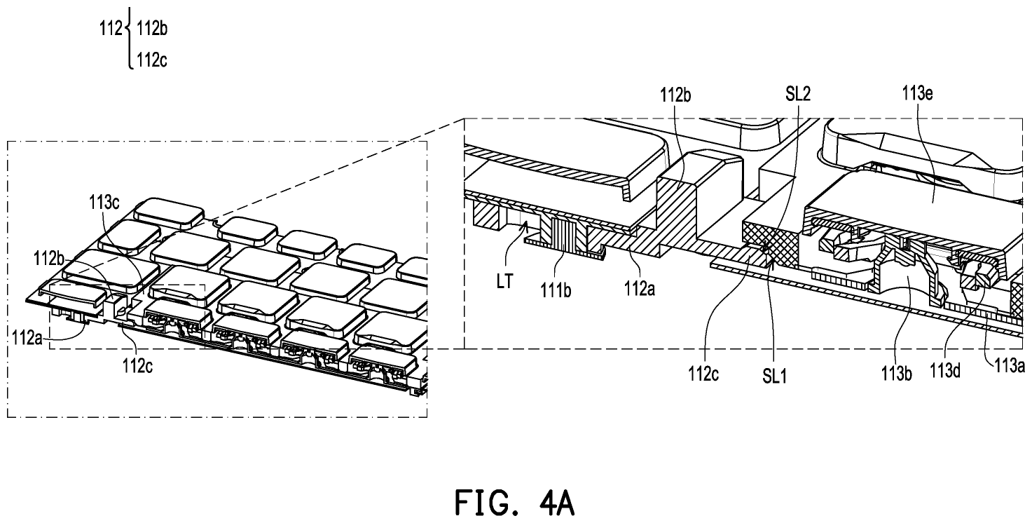

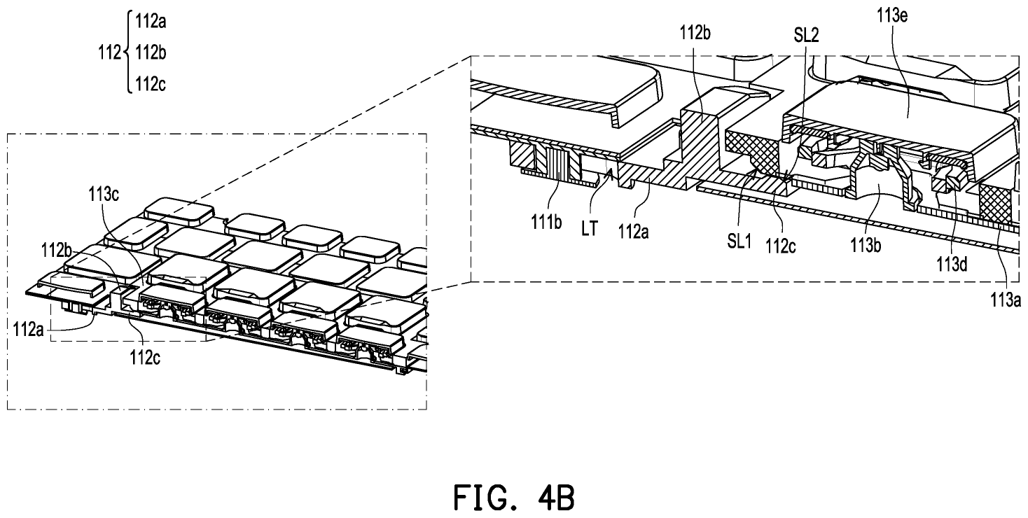

FIG. 4A and FIG. 4B are partial cross-sectional views of a first key module before and after driving. Please refer to FIG. 4A and FIG. 4B at the same time. The latching member 112 of the embodiment has a plate body 112a, a driving part 112b, and a pushing part 112c. The plate body 112a is movably coupled to the bracket 111. The driving part 112b extends and protrudes from the plate body 112a and is located between the first key module KM1 and the second key module KM2 (e.g., as shown in FIG. 2A), and the pushing part 112c extends parallelly from the plate body 112a towards the first key module KM1. Furthermore, the bracket 111 has a guide column 111b, and the plate body 112a has a guide groove LT. The guide column 111b is movably coupled to the guide groove LT such that the plate body 112a may move back and forth along the bracket 111 (as shown in the process of FIG. 4A to FIG. 4B, or the process of FIG. 4B to FIG. 4A).

Furthermore, a bottom surface of the frame 113c of the key group 113 has a first slope SL1, and the latching member 112 has a second slope SL2. When the first key module KM1 is assembled onto the bracket 111, the first slope SL1 is relatively moved away from the second slope SL2, and the first slope SL1 is located on a moving path of the second slope SL2 (as shown in FIG. 4A). When the user applies a force to push the latching member 112, the pushing part 112c having the second slope SL2 pushes the first slope SL1 of the first key module KM1 to push the part of the first key module KM1 away from the bracket 111 (as shown in FIG. 4B).

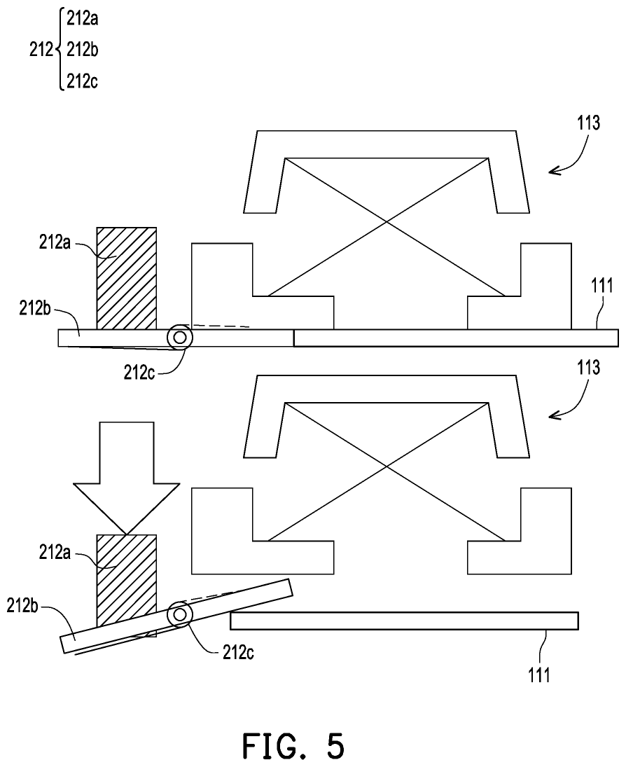

FIG. 5 is a simple schematic view of a key module being driven according to another embodiment of the disclosure. Different from the above-mentioned embodiments, the latching member 212 of the embodiment has a plate body 212b and a driving part 212a. The plate body 212b is pivotally connected to the bracket 111 to form a seesaw structure. The driving part 212a is located at one end of the seesaw structure and extends from the plate body 212b to be between the first key module KM1 and the second key module KM2 (like the above-mentioned driving part 112b). The part of the first key module KM1 (key group 113) is located at another end of the seesaw structure. The user applies a force on the driving part 212a to perform a pressing action. That is, the plate body 212b may push the key group 113 away through the seesaw structure. Furthermore, the latching member 212 also has a torsion spring 212c sheathed in a pivot joint between the plate body 212b and the bracket 111. The torsion spring 212c constantly drives the plate body 212b to switch from the state shown at the bottom of FIG. 5 to the state shown at the top of FIG. 5, that is, to allow the plate body 212b to be reset and be available for pressing again.

To sum up, in the above embodiments of the disclosure, the keyboard of the laptop computer has the first key module and the second key module that are different from each other. The first key module is detachably assembled onto the bracket, and the driving thereof with the use of the latching member allows the first key module to be dismounted from the bracket.

Furthermore, the keyboard of the laptop computer is a QWERTY keyboard, and is further divided into the first key module and the second key module. The second key module is fixedly disposed on the bracket, and the first key module is detachably assembled onto the bracket. Accordingly, the user may obtain a key structure suitable for the current use environment by disassembling and replacing the first key module.

Furthermore, since the first backlight module, the first tactile film, and the key group of the first key module are sequentially disposed on the bracket, the first tactile film and the first backlight module are also in a detachable and replaceable state in addition to the key structure of the key group itself. Therefore, in addition to the marking pattern on the key cap, the first key module in this case may further change the pressing stroke, pressing feel, or further appearance effects (such as changing the backlight mode) to further meet the requirements of users and expand the applicable scope of the laptop computer.

What is claimed is:

1. A laptop computer, comprising:
a body;
a bracket, disposed in the body;
a latching member, movably disposed on the bracket;
a first key module, detachably assembled onto the bracket, wherein a part of the first key module is located on a moving path of the latching member, and the latching member is adapted to be driven by an external force to push the part of the first key module away from the bracket; and
a second key module, disposed on the bracket.

2. The laptop computer according to claim 1, wherein the first key module comprises:
a bottom plate, carried on the bracket;
a frame, disposed on the bottom plate, wherein a part of the frame is located on the moving path of the latching member;
a plurality of elastic domes;
a plurality of scissor structures, movably disposed on the bottom plate, and surrounding the elastic domes; and
a plurality of key caps, respectively disposed on the scissor structures, wherein top parts of the elastic domes are respectively connected to the key caps.

3. The laptop computer according to claim 2, wherein a bottom surface of the frame has a first slope, the latching member has a second slope, and the first slope is located on a moving path of the second slope when the first key module is assembled onto the bracket.

4. The laptop computer according to claim 2, wherein the first key module further comprises at least one magnetic attraction member disposed on the bottom plate, and the bracket has magnetic attraction such that the first key module is fixed on the bracket through magnetic attraction.

5. The laptop computer according to claim 1, wherein the latching member has a plate body, a driving part, and a pushing part, the plate body is movably coupled to the bracket, the driving part extends and protrudes from the plate body and is located between the first key module and the second key module, and the pushing part extends parallelly from the plate body towards the first key module.

6. The laptop computer according to claim 5, wherein one of the bracket and the plate body has a guide column, the other of the bracket and the plate body has a guide groove, and the guide column is movably coupled to the guide groove such that the plate body moves along the bracket.

7. The laptop computer according to claim 5, wherein the pushing part has a second slope to push a first slope of the first key module so as to push the part of the first key module away from the bracket.

8. The laptop computer according to claim 2, wherein the first key module further comprises a first tactile film disposed between the bracket and the bottom plate, and each of the elastic domes passes through the bottom plate and stands on the first tactile film.

9. The laptop computer according to claim 8, further comprising a control module, wherein the second key module also comprises a second tactile film disposed on the bracket, the first tactile film and the second tactile film are independent of each other and do not belong to each other, and the first tactile film and the second tactile film are electrically connected to the control module, respectively.

10. The laptop computer according to claim 9, wherein an effective tactile area of the second tactile film has a first notch, and an effective tactile area of the first tactile film is located inside the first notch.

11. The laptop computer according to claim 2, wherein the first key module further comprises a first backlight module disposed between the bracket and the bottom plate to provide light.

12. The laptop computer according to claim 11, further comprising a control module, wherein the second key module further comprises a second backlight module disposed on the bracket and used to provide light, the first backlight module and the second backlight module are independent of each other and do not belong to each other, and the first backlight module and the second backlight module are electrically connected to the control module, respectively.

13. The laptop computer according to claim 12, wherein an effective light source area of the second backlight module has a second notch, and an effective light source area of the first backlight module is located inside the second notch.

14. The laptop computer according to claim 1, wherein the latching member has a plate body and a driving part, the plate body is pivotally connected to the bracket to form a seesaw structure, the driving part is located at one end of the seesaw structure and extends from the plate body to be between the first key module and the second key module, and the part of the first key module is located at the other end of the seesaw structure.

15. The laptop computer according to claim 1, wherein the first key module comprises first four keys of a first row and first four keys of a second row in a letter area of a QWERTY keyboard.
